(19) United States
(12) Patent Application Publication
(10) Pub. No.: US 2025/0156466 A1
(43) Pub. Date: May 15, 2025

(54) DOCUMENT READING SUPPORT METHOD

(71) Applicant: Semiconductor Energy Laboratory Co., Ltd., Atsugi-shi (JP)

(72) Inventors: Yoshitaka DOZEN, Atsugi (JP); Kunitaka YAMAMOTO, Atsugi (JP)

(21) Appl. No.: 18/931,462

(22) Filed: Oct. 30, 2024

(30) Foreign Application Priority Data
Nov. 9, 2023 (JP) 2023-191708

(51) Int. Cl. G06F 16/34; G06F 40/284

(52) U.S. Cl. CPC G06F 16/345; G06F 40/284

(57) ABSTRACT

A document reading support method using a language model is provided. The document reading support method includes the steps of: displaying a segmented document; receiving selection of a part of the document; inputting the part and an instruction sentence for summarizing the part to a language model; determining whether the number of tokens of the part is less than or equal to a predetermined value; and obtaining a summary of the part determined to have the tokens of less than or equal to the predetermined value.

### BACKGROUND OF THE INVENTION

### 1. Field of the Invention

The present invention relates to a document reading support method utilizing a language model, especially, a generative AI model.

The above technical field is one embodiment of the present invention, and the present invention is not limited to the above technical field. Examples of other embodiments of the present invention include a semiconductor device, a display device, a light-emitting device, a power storage device, a memory device, an electronic device, a lighting device, an input device (e.g., a touch sensor), an input/output device (e.g., a touch panel), driving methods thereof, and manufacturing methods thereof.

### 2. Description of the Related Art

Document reading requires an accurate understanding of contents. In addition, document reading requires a general understanding to achieve the purpose of a reader. However, a reader sometimes makes an interpretation by freely connecting words, failing to accurately understand a document. In the case of a long document, it takes a long time for a reader to read the document. In the case of a patent-related document (typically, a patent specification, a published application, or a patent publication, which is referred to as a patent document), drawings are often attached thereto but are apart from descriptions of the drawings. This requires a reader to look at both the drawings and the descriptions separately to understand the document; thus, the reader sometimes fails to find some information related to technical contents. Patent Document 1 discloses a system that enables efficient reading of a patent document by displaying the content of a specification and drawings side by side horizontally.

ChatGPT can be given as an example of an interactive large language model (LLM). Known LLMs used for ChatGPT are Generative Pre-trained Transformer 3 (GPT-3), Generative Pre-trained Transformer 4 (GPT-4), and the like.

### REFERENCE

[Patent Document 1] Japanese Published Patent Application No. H8-339380

### SUMMARY OF THE INVENTION

A conventional document reading support method cannot provide sufficient support in some cases. For example, a document reading support method of simply displaying the content of a specification and drawings side by side horizontally as in Patent Document 1 requires a long time for reading and fails to provide an accurate understanding in some cases.

A language model such as a conversational generative model can be used in an attempt to generate a summary of a document. However, when a language model based on a transformer architecture is used, the maximum number of characters that can be entered is limited by a facility or a memory used, and it is sometimes difficult to load the whole document to generate a summary. In addition, effort is required to extract a sentence from a document (prepare an extracted sentence) so as to obtain a proper number of characters. Furthermore, a difference in knowledge or experience among persons who extract a sentence causes variation in quality of the extracted sentence. Document reading support is desired to achieve the purpose of a user, but mismatch of the extracted sentence with a topic results in extremely low-efficiency processing.

The present invention has been made in view of the above problems, and an object of one embodiment of the present invention is to provide a novel document reading support method. Another object of one embodiment of the present invention is to provide a document reading support method which uses a language model and enables an appropriate prompt to be obtained. Another object of one embodiment of the present invention is to provide a document reading support method which uses a language model and enables an accurate answer sentence to be obtained.

The present invention does not necessarily need to achieve all of these objects. The description of these objects does not disturb the existence of other objects of the present invention. Other objects can be derived from the description of the specification, the drawings, and the scope of claims, for example.

In view of the above objects, one embodiment of the present invention is a document reading support method including the steps of: displaying a segmented document (referred to as a first document so as to be distinguished from another document); receiving selection of a part of the first document (referred to as a second document so as to be distinguished from another document); inputting the second document and an instruction sentence for summarizing the second document to a language model; determining whether the number of tokens of the second document is less than or equal to a predetermined value; and obtaining a summary of the second document determined to have the tokens of less than or equal to the predetermined value.

Another embodiment of the present invention is a document reading support method including the steps of: displaying a document segmented into a plurality of sections including at least a first section; receiving selection of the first section; inputting the first section and an instruction sentence for summarizing the first section to a language model; determining whether the number of tokens of the first section is less than or equal to a predetermined value; and obtaining a summary of the first section determined to have the tokens of less than or equal to the predetermined value. Note that the document includes the plurality of sections, and any one of the plurality of sections is referred to as the first section.

Another embodiment of the present invention is a document reading support method including the steps of: displaying at least one drawing and a segmented document; receiving selection of the at least one drawing; collecting a sentence related to the selected drawing from the document; inputting the collected sentence and an instruction sentence for summarizing the collected sentence to a language model; determining whether the number of tokens of the collected sentence is less than or equal to a predetermined value; and obtaining a summary of the collected sentence determined to have the tokens of less than or equal to the predetermined value.

Another embodiment of the present invention is a document reading support method including the steps of: displaying a segmented document including at least one word; searching the document for the word and collecting a paragraph including the word from the document; inputting the collected paragraph and an instruction sentence for summarizing the collected paragraph to a language model; determining whether the number of tokens of the collected paragraph is less than or equal to a predetermined value; and obtaining a summary of the collected paragraph determined to have the tokens of less than or equal to the predetermined value.

In the present invention, the word may be followed by a letter or a number.

In the present invention, the document may be in a first language, the instruction sentence may be in a second language, and the summary generated by the language model may be in the first language.

In the present invention, the summary may be translated into the first language from the second language.

In the present invention, it is preferable that the document reading support method further include the step of displaying the summary generated by the language model and a first word not used in the document be highlighted in the displayed summary.

In the present invention, it is preferable that the document reading support method further include the step of displaying the summary generated by the language model and a sentence including a second word in the document be displayed when the second word is selected in the displayed summary.

In the present invention, it is preferable that an alert be displayed when the number of tokens is greater than the predetermined value in the step of determining whether the number of tokens is less than or equal to the predetermined value.

One embodiment of the present invention can provide a novel document reading support method. Another embodiment of the present invention can provide a document reading support method which uses a language model and enables an appropriate prompt to be selected. Another object of one embodiment of the present invention can provide a document reading support method which uses a language model and enables an accurate answer sentence to be obtained.

The present invention does not necessarily need to have all of these effects. The description of these effects does not disturb the existence of other effects of the present invention. Other effects can be derived from the description of the specification, the drawings, and the scope of claims, for example.

### BRIEF DESCRIPTION OF THE DRAWINGS

FIG. 1 illustrates a configuration example of a system which enables a document reading support method of the present invention.

FIG. 2 illustrates a configuration example of a data processing device which enables a document reading support method of the present invention.

FIG. 3 is a flowchart illustrating an example of a document reading support method of the present invention.

FIGS. 4A and 4B illustrate an example of a change in screen of an information terminal used for a document reading support method of the present invention.

FIG. 5 illustrates an example of a system which enables a document reading support method of the present invention.

FIG. 6 illustrates a specific configuration example of a system which enables a document reading support method of the present invention.

### DETAILED DESCRIPTION OF THE INVENTION

Embodiments of the present invention will be described with reference to the drawings. Note that it is easily understood by those skilled in the art that modes of the present invention can be changed in various ways without departing from the spirit thereof. Therefore, the present invention should not be construed as being limited to the description in the following embodiments.

The position, size, range, and the like of each component in the drawings and the like do not accurately represent those of an actual component in some cases. Thus, the position, size, range, and the like of each component are not necessarily limited to the position, size, range, and the like disclosed in the drawings.

In this specification and the like, a language model is a conversational (also referred to as interactive) model based on a transformer architecture and obtained by additional learning. In other words, a conversational generative model corresponds to a subordinate concept of the language model. The language model is also generally referred to as a large language model.

In this specification and the like, the terms “first” and “second” are sometimes used for easy understanding of the technical contents or identification of components. Thus, the terms “first” and “second” do not limit the number of components. In addition, the terms “first” and “second” do not limit the order of components. In addition, the terms such as “first” and “second” or identification numerals used in this specification do not correspond to the terms or the identification numerals in the scope of claims of this application in some cases.

In this specification and the like, a document refers to a written representation of a person's intention with characters or symbols. The document may be a book, a patent document, or a paper, for example. The document includes in its category the state of being segmented into a plurality of sections or a plurality of paragraphs. One section includes in its category the state of being composed of a plurality of paragraphs.

### Embodiment

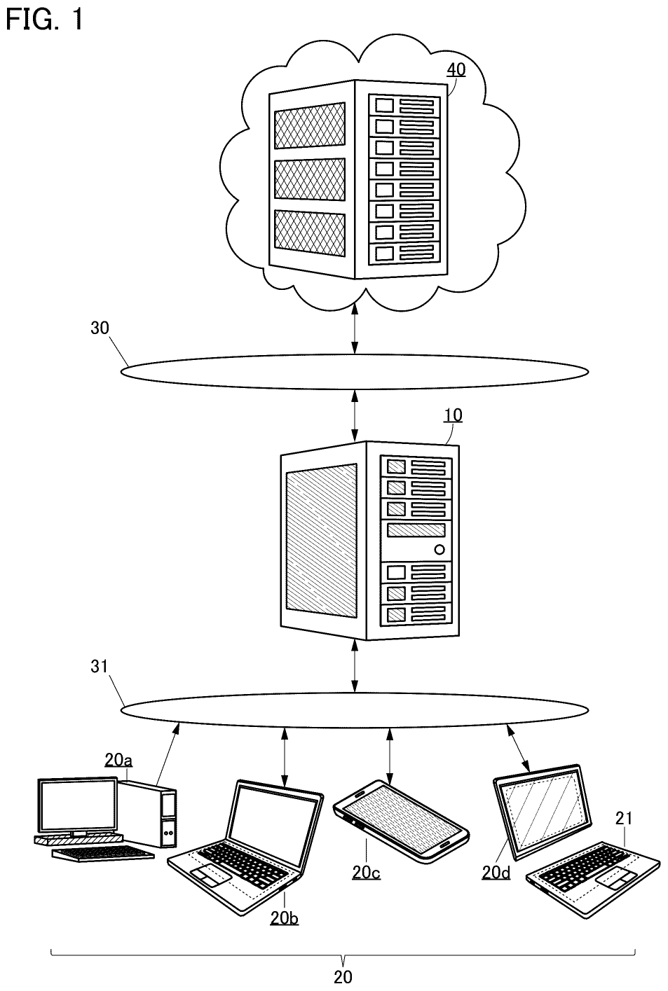

In this embodiment, a configuration example of a data processing system of one embodiment of the present invention which enables document reading support will be described with reference to FIG. 1. The data processing system which enables document reading support is referred to as a reading support system in some cases.

### <Configuration Example of Data Processing System>

A data processing system of this embodiment preferably includes a first data processing device 10, a second data processing device 40, a first information terminal 20a, a second information terminal 20b, a third information terminal 20c, and a fourth information terminal 20d as illustrated in FIG. 1. The first information terminal 20a, the second information terminal 20b, the third information terminal 20c, and the fourth information terminal 20d are collectively referred to as a plurality of information terminals 20.

As illustrated in FIG. 1, the first data processing device 10 is connected to each of the plurality of information terminals 20 through a network 31. The first data processing device 10 is connected to the second data processing device 40 through a network 30.

Each of the first to fourth information terminals 20a to 20d is operated by a user of the document reading support system and can also be referred to as a client computer or the like. As one example, FIG. 1 illustrates a desktop computer as the first information terminal 20a, a laptop computer as the second information terminal 20b, a smartphone as the third information terminal 20c, and a tablet computer as the fourth information terminal 20d. Note that the fourth information terminal 20d is detachable from a housing 21 which includes an input unit (typically, a keyboard).

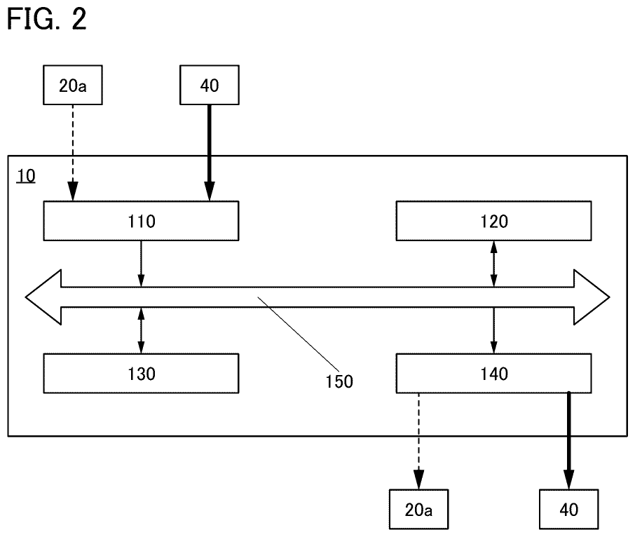

Next, in this embodiment, a configuration example of the first data processing device or the like of one embodiment of the present invention which enables document reading support will be described with reference to FIG. 2.

### <<Configuration Example of First Data Processing Device 10>>

The first data processing device 10 of one embodiment of the present invention includes an input unit 110, a memory unit 120, a processing unit 130, an output unit 140, and a transmission path 150 as illustrated in FIG. 2. Note that FIG. 2 illustrates the first information terminal 20a and the second data processing device 40 in addition to the first data processing device 10, and arrows indicate data transmission and reception.

### [Input Unit 110]

The input unit 110 can receive data from the outside of the first data processing device 10. For example, the input unit 110 can receive data from the first information terminal 20a. The input unit 110 can also receive data from the second data processing device 40.

The input unit 110 can supply the received data to one or both of the memory unit 120 and the processing unit 130 through the transmission path 150.

### [Memory Unit 120]

The memory unit 120 has a function of storing a program to be executed by the processing unit 130, for example. The memory unit 120 may have a function of storing data (e.g., a calculation result, an analysis result, or an inference result) generated by the processing unit 130. The memory unit 120 may also have a function of storing the data received by the input unit 110, for example.

The memory unit 120 may include a database. The database can store and manage data of a document described later. The first data processing device 10 may include a database different from that of the memory unit 120. Specifically, the first data processing device 10 may have a function of extracting data from a database outside the memory unit 120, a database outside the first data processing device 10, or a database outside the data processing system. The first data processing device 10 may have a function of extracting data from both the database inside the first data processing device 10, i.e., the database included in itself, and the database outside the first data processing device 10.

The memory unit 120 includes at least one of a volatile memory and a nonvolatile memory. Examples of the volatile memory include a dynamic random access memory (DRAM) and a static random access memory (SRAM). Examples of the nonvolatile memory include a resistive random access memory (ReRAM, also referred to as a resistance-change memory), a phase-change random access memory (PRAM), a ferroelectric random access memory (FeRAM), a magnetoresistive random access memory (MRAM, also referred to as a magnetoresistive memory), and a flash memory. The memory unit 120 can include a Si LSI (a circuit including silicon transistors).

The memory unit 120 may include at least one of a NOSRAM (registered trademark) and a DOSRAM (registered trademark). The memory unit 120 may include a recording media drive. Examples of the recording media drive include a hard disk drive (HDD) and a solid-state drive (SSD).

The NOSRAM is an abbreviation for a nonvolatile oxide semiconductor random access memory (RAM). The NOSRAM includes a two-transistor (2T) or three-transistor (3T) gain memory cell and refers to a memory including transistors whose channel formation regions are formed using a metal oxide (also referred to as OS transistors). OS transistors have an extremely low current that flows between their sources and drains in an off state, that is, an extremely low leakage current. The NOSRAM can be used as a nonvolatile memory by retaining electric charge corresponding to data in the memory cell, using the characteristic of an extremely low leakage current. In particular, the NOSRAM is capable of reading retained data without destruction (non-destructive reading), and thus is suitable for arithmetic processing in which only a data reading operation is repeated many times. NOSRAM memory cells can be stacked. The stack of NOSRAM memory cells enables an increase in data capacity and thus enables an improvement in performance when used as a large-scale cache memory, a large-scale main memory, or a large-scale storage memory.

The DOSRAM is an abbreviation for a dynamic oxide semiconductor RAM and refers to a RAM including a one-transistor (1T) and one-capacitor (1C) memory cell. The DOSRAM is a DRAM formed using an OS transistor and refers to a memory which temporarily stores data sent from the outside. The DOSRAM is a memory utilizing the low off-state current of the OS transistors.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide included in the channel formation region preferably contains indium (In), i.e., indium oxide. An OS transistor formed using a metal oxide containing indium in its channel formation region has a high carrier mobility (electron mobility). The metal oxide included in the channel formation region is preferably an oxide semiconductor containing an element M described later instead of In or in addition to In. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. The metal oxide may contain a combination of a plurality of the elements listed as the element M. The element M is an element having a high bonding energy with oxygen, and its bonding energy with oxygen is higher than the bonding energy of indium with oxygen. The metal oxide included in the channel formation region is preferably a metal oxide containing zinc (Zn) instead of In or in addition to In. The metal oxide containing zinc is easily crystallized in some cases.

The metal oxide included in the channel formation region is not limited to the metal oxide containing the above element, typically, indium. The metal oxide included in the channel formation region may be, for example, a metal oxide that does not contain indium and contains any of zinc, gallium, and tin (e.g., zinc tin oxide or gallium tin oxide).

### [Processing Unit 130]

The processing unit 130 has a function of performing processing such as calculation, analysis, and inference with the use of data supplied from one or both of the input unit 110 and the memory unit 120. The processing unit 130 can supply processed data (e.g., a calculation result, an analysis result, or an inference result) to one or both of the memory unit 120 and the output unit 140.

The processing unit 130 has a function of obtaining data from the memory unit 120. The processing unit 130 may have a function of storing or registering data in the memory unit 120.

The processing unit 130 can include an arithmetic circuit, for example. The processing unit 130 can include, for example, a central processing unit (CPU). The CPU includes an arithmetic unit, a primary cache memory, a secondary cache memory, and the like. The processing unit 130 can include a graphics processing unit (GPU). The GPU includes an arithmetic unit, a primary cache memory, a secondary cache memory, and the like. The CPU or the GPU can include one or both of an OS transistor and a transistor containing silicon in a channel formation region (a Si transistor).

The processing unit 130 may include a register and a main memory in addition to the CPU or the GPU. The register and the main memory are sometimes included in the CPU. Alternatively, the register and the main memory are sometimes included in the GPU. The main memory can transmit and receive data to and from the secondary cache or the like. The main memory includes at least one of a volatile memory such as a random access memory (RAM) and a nonvolatile memory such as a read only memory (ROM). The main memory may include at least one of the above-described NOSRAM and DOSRAM. The main memory can include one or both of an OS transistor and a Si transistor.

For example, a DRAM, an SRAM, or the like is used as the RAM, a virtual memory space is assigned and utilized as a working space of the processing unit 130. An operating system, an application program, a program module, program data, a look-up table, and the like which are stored in the memory unit 120 are loaded into the RAM for execution. The data, program, and program module which are loaded into the RAM are each operated by access to the processing unit 130.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultra-violet erasable programmable read only memory (UV-EPROM) which can erase stored data by irradiation with ultraviolet rays, an electrically erasable programmable read only memory (EEPROM), and a flash memory.

The processing unit 130 may include a microprocessor such as a digital signal processor (DSP). The DSP is specialized in digital signal processing and is thus preferably included to control a peripheral circuit such as a CPU. The microprocessor may be configured with a programmable logic device (PLD), which is operated by hardware, such as a field programmable gate array (FPGA) or a field programmable analog array (FPAA). The processing unit 130 may include a quantum processor. The processing unit 130 can interpret and execute instructions from programs with use of a processor to process various kinds of data and control programs. The programs to be executed by the processor are stored in at least one of a memory region of the processor or the memory unit 120.

The processing unit 130 preferably includes an OS transistor. The OS transistor has an extremely low off-state current; therefore, with the use of the OS transistor as a switch for retaining electric charge (data) that has flowed into a capacitor, a long data retention period can be ensured. When at least one of a register and a cache memory included in the processing unit 130 has such a feature, the processing unit 130 can be operated only when needed, and otherwise can be off while data processed immediately before turning off the processing unit 130 is stored in the capacitor. In other words, the OS transistor enables normally-off computing and reduces the power consumption of the data processing system.

When a CPU or the like capable of high-speed operation is used in the processing unit 130, AI can be used for part of processing executed by the first data processing device 10. The first data processing device 10 preferably includes an artificial neural network (ANN, hereinafter also simply referred to as a neural network) to enable processing using AI. Since the neural network can be implemented by a circuit (hardware) or a program (software), the first data processing device 10 preferably includes the circuit or the program.

In this specification and the like, the neural network indicates a general model having the capability of solving problems, which is modeled on a biological neural network and determines the connection strength of neurons by learning. The neural network includes an input layer to which data is input, an output layer from which data is output, and an intermediate layer (a hidden layer) between the input layer and the output layer, and a weight for input data is optimized in order to obtain a correct output result.

In the description of the neural network in this specification and the like, to determine a weight coefficient between neurons from the existing information is referred to as “learning” in some cases.

In this specification and the like, to draw a new conclusion from a neural network formed with the weight coefficient obtained by learning is referred to as “inference” in some cases.

### [Output Unit 140]

The output unit 140 can output a calculation result or the like from the processing unit 130 to the outside of the first data processing device 10. For example, the output unit 140 can transmit data to the second data processing device 40. The output unit 140 can also transmit data to the plurality of information terminals 20.

### [Transmission Path 150]

The transmission path 150 has a function of transmitting data. Data transmission and reception between the input unit 110, the memory unit 120, the processing unit 130, and the output unit 140 can be performed through the transmission path 150.

### <<Configuration Example of Second Data Processing Device 40>>

The second data processing device 40 can process received data and transmit the result of the processing. For example, the second data processing device 40 can perform processing such as calculation using data received from the first data processing device 10. In addition, the second data processing device 40 can transmit the result of the processing to the first data processing device 10. Accordingly, the load of calculations on the first data processing device 10 can be reduced.

The second data processing device 40 can perform processing using a natural language processing model using AI. For example, the second data processing device 40 can execute processing using a natural language processing model using AI such as Bidirectional Encoder Representations from Transformers (BERT) or Text-to-Text Transfer Transformer (T5).

The second data processing device 40 can also perform processing using a model (e.g., a document generation model or an interaction model) utilizing a large language model. Generation of a summary sentence in Step S151 described later is preferably performed using the model utilizing a large language model. For example, processing can be executed using a large language model such as GPT-3, GPT-3.5, GPT-4, Language Model for Dialogue Applications (LaMDA), Pathways Language Model (PaLM), or Llama2.

The second data processing device 40 can execute processing using a general-purpose language processing model capable of performing a variety of natural language processing tasks. Note that a document reading support service provider does not necessarily own the second data processing device 40 by itself. For example, the service provider can utilize part of a service provided by another service provider or the like using the second data processing device 40.

<<Configuration Example of First Information Terminal 20a>>

The first information terminal 20a can receive data that is input by a user. The first information terminal 20a can provide the user with data that is output from the data processing system of one embodiment of the present invention.

The first information terminal 20a can transmit the data received from the user to the first data processing device 10. The first information terminal 20a can provide the user with data that is received from the first data processing device 10.

The first information terminal 20a can transmit data that is generated using the data received from the user to the first data processing device 10. The first information terminal 20a can provide the user with data that is generated using the data received from the first data processing device 10.

Dedicated application software, a dedicated web browser, or the like is installed on the first information terminal 20a, for example. The user can access the first data processing device 10 through any of the dedicated application software, the dedicated web browser, and the like. Thus, the user can receive a service using the data processing system of one embodiment of the present invention by using a computer whose processing capability is lower than that of the first data processing device 10, for example.

The first information terminal 20a can also be referred to as a client computer or the like. The plurality of information terminals 20 are each operated by a user.

### <<Network 30>>

The network 30 connects the first data processing device 10 and the second data processing device 40 to each other. Thus, input data and processed data can be transmitted and received therebetween. In addition, a load related to data processing can be dispersed. Note that the case where the network 30 is a larger computer network than the network 31 is mainly described in this embodiment. For example, a global network can be used as the network 30. Specifically, the Internet, which is an infrastructure of the World Wide Web (WWW), can be used.

### <<Network 31>>

The network 31 connects the plurality of information terminals 20 and the first data processing device 10 to each other. Thus, data can be transmitted and received therebetween. In addition, the load related to data processing can be dispersed. Furthermore, the service provider can provide a user with the service using the data processing method of one embodiment of the present invention through the network 31, for example.

For example, a local network can be used as the network 31. An intranet or an extranet can be used as the network 31. A personal area network (PAN), a local area network (LAN), a campus area network (CAN), a metropolitan area network (MAN), a wide area network (WAN), or a global area network (GAN) can be used as the network 31.

For wireless communication, it is possible to use, as a communication protocol or a communication technology, a communication standard such as the fourth-generation mobile communication system (4G), the fifth-generation mobile communication system (5G), or the sixth-generation mobile communication system (6G), or a communication standard developed by IEEE such as Wi-Fi (registered trademark) or Bluetooth (registered trademark).

In the case where the provider of the service using the document reading support method of one embodiment of the present invention and a user who receives the service belong to the same organization such as the same company, data transmission and reception between the plurality of information terminals 20 and the first data processing device 10 are preferably performed using the network 31 constructed within the organization, for example. Thus, data can be transmitted and received between the plurality of information terminals 20 and the second data processing device 40 more safely than in the case where data is transmitted and received through the Internet. In addition, confidential information in the organization can be prevented from leaking to the outside. Alternatively, data transmission and reception between the plurality of information terminals 20 and the first data processing device 10 may be performed using the network 30 (e.g., the Internet).

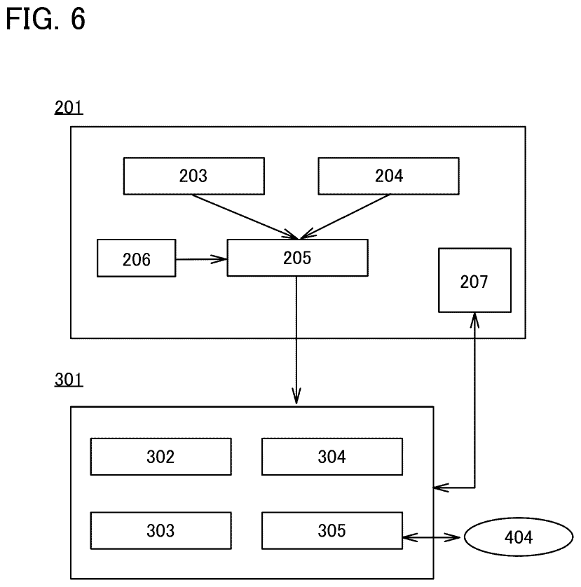

A more specific configuration example of the document reading support system in this embodiment will be described with reference to FIG. 6. A server computer 201 includes an input unit, a memory unit, a processing unit, an output unit, and a transmission path and is also referred to as a backend. The processing unit of the server computer 201 includes a text data supply unit 203 and a drawing data supply unit 204 as illustrated in FIG. 6. The text data supply unit 203 has a function of structuring text data of a document to be subjected to reading support and a function of supplying the structured data to a display data processing unit 205. Examples of the structuring include text segmentation into paragraphs and text segmentation into sections each including a plurality of paragraphs. In the case of a patent document, one example of the structuring is segmentation into sections such as Embodiment 1 and Embodiment 2. Alternatively, since Embodiment 1 includes a plurality of paragraphs (paragraph numbers), another example is segmentation into a section including those paragraphs (paragraph numbers). Text data of segmented text may be stored in the memory unit. The drawing data supply unit 204 supplies image data of a drawing included in a document to the display data processing unit 205. For example, image data linked to each drawing number may be used as image data. The display data processing unit 205 constructs data on the relationship between a drawing and text so that the user can see the drawing and the corresponding text displayed side by side on the screen. Specifically, the display data processing unit 205 performs processing for embedding an HTML tag in each of text data and image data of a drawing. For example, image data of FIG. A can be displayed in a state where a link to a paragraph X referring to FIG. A is embedded as a tag, and the paragraph X referring to FIG. A can be displayed in a state where a link to FIG. A is embedded as a tag. The display data processing unit 205 can recognize a segmented section and form a button for giving an instruction regarding the section to the language model. Moreover, the display data processing unit 205 can obtain an instruction sentence for the language model from a prompt data supply unit 206. Data generated in the display data processing unit 205 is preferably transmitted as display data in an HTML format for display to an individual terminal 301 operated by a user.

The individual terminal 301 includes an input unit, a memory unit, a processing unit, an output unit, and a transmission path, is also referred to as a frontend, and corresponds to a terminal operated by the user. In the individual terminal 301, display data received from the server computer 201 is processed by a display processing unit 302 for text display or operation or drawing display or operation, and the processed display data is displayed by a display device 304. The display device 304 includes a panel unit for enabling display. The display processing unit 302 is a browser, for example. A prompt processing unit 303 enables the user to specify a section as a subject to be summarized or edit a prompt by means of the display device 304. A communication processing unit 305 transmits and receives a prompt to and from a language model 404 and feeds back received data to the display processing unit 302 so that the display device 304 can display an answer from the language model. The answer received by the individual terminal 301 may be transmitted to the server computer 201 for further processing in the server computer 201. Note that the language model 404 may be installed in a cloud environment so that it can be used through the Internet or a communication line, or may be installed on the server computer 201. Although not illustrated, the language model 404 can also transmit and receive a prompt to and from the individual terminal 301 through the server computer 201.

The document reading support system in this embodiment may have a function of enabling the user to perform a text search through text displayed on the display device 304. In that case, a search processing unit 207 provided in the server computer 201 reconstructs text data in response to a text search instruction from the individual terminal 301. The reconstructed text data is transmitted to the display processing unit 302 of the individual terminal 301.

### <Example Related to Method>

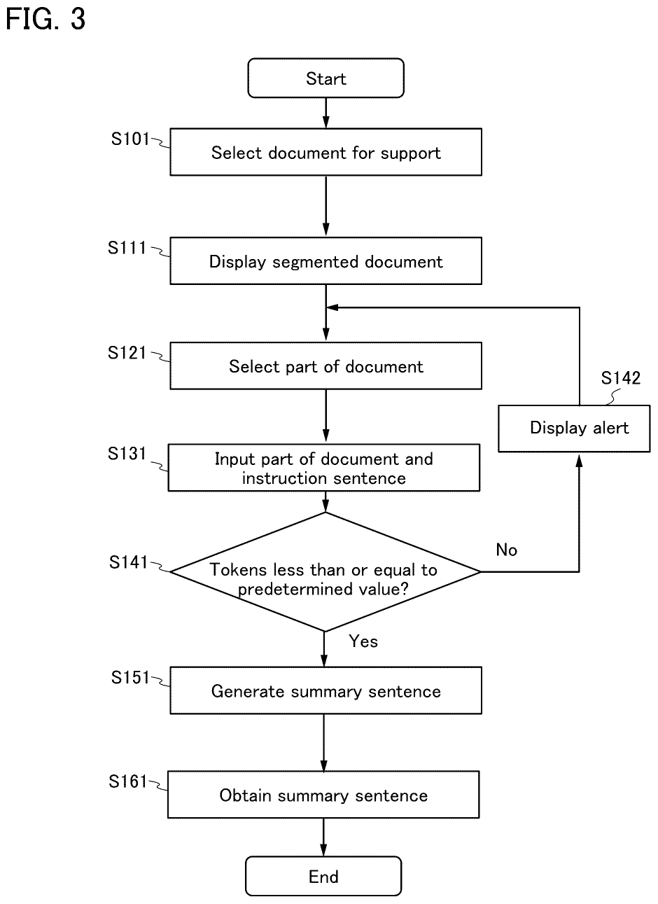

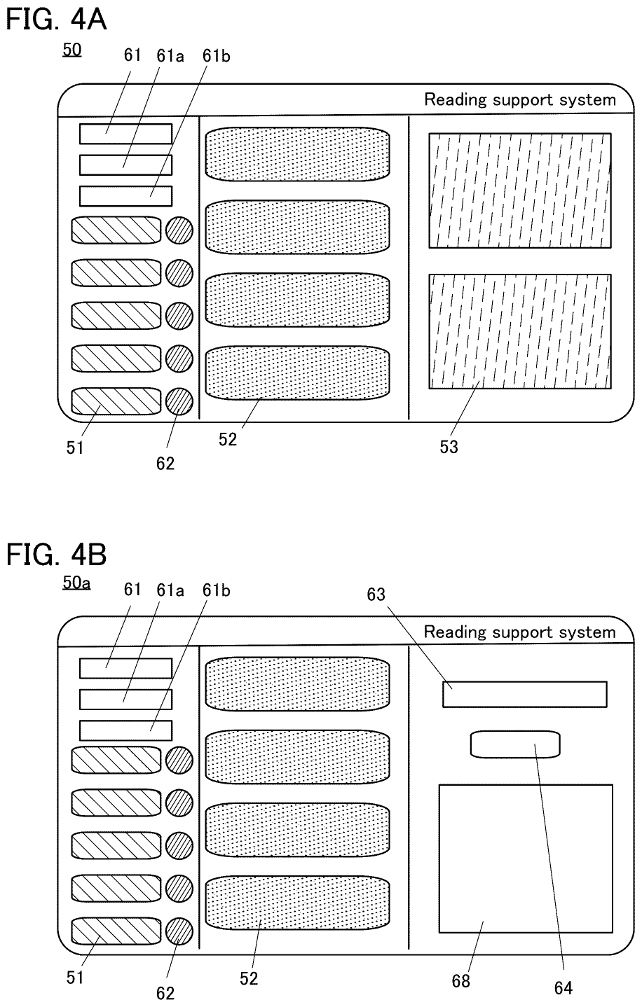

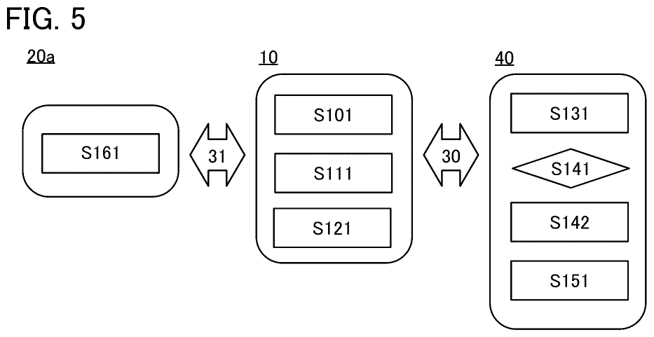

In this embodiment, a document reading support method or the like of one embodiment of the present invention will be described. FIG. 3 is an example of a flowchart related to the document reading support method of one embodiment of the present invention. FIGS. 4A and 4B illustrate an example of a change in screen of the first information terminal 20a in the document reading support method. FIG. 5 illustrates data processing performed in the first information terminal 20a, the first data processing device 10, and the second data processing device 40, which will be described with reference to the step numbers in the flowchart in FIG. 3.

The document reading support method of one embodiment of the present invention is started, and the user selects a document for document reading support as denoted by Step S101 in FIG. 3. As the document, a patent document is typically preferably used in the document reading support method of one embodiment of the present invention. Input related to Step S101 is preferably performed with the first information terminal 20a, and as illustrated in FIG. 4A, a screen 50 of the first information terminal 20a preferably includes a text box 61 as display corresponding to Step S101. Main data processing related to Step S101 is preferably executed by the first data processing device 10 as illustrated in FIG. 5. One example of the main data processing is processing in which the input unit 110 receives data from the first information terminal 20a, the data is supplied to one or both of the memory unit 120 and the processing unit 130 through the transmission path 150, and at least the processing unit 130 selects a document based on the data. The document can be selected from the database included in the memory unit 120 or the database outside the first data processing device 10.

Note that the screen 50 may be provided with a list button 61a for displaying a list of a plurality of documents, instead of the text box 61 or in addition to the text box 61. FIG. 4A illustrates the screen 50 provided with the list button 61a in addition to the text box 61. In that case, the user can select a document from the list. The list can be stored using the database included in the memory unit 120 or the database outside the first data processing device 10. The document selected from the list is transmitted to the first information terminal 20a through the output unit 140.

The screen 50 may be provided with a search button 61b for executing a search through a plurality of documents, instead of the text box 61 or in addition to the text box 61. FIG. 4A illustrates the screen 50 provided with the search button 61b in addition to the text box 61. When the search button 61b is selected, a box for entering a search keyword may be displayed on the screen 50 or a new screen different from the screen 50. The user can select a document according to a search result. Data processing related to the search can be executed by the processing unit 130 of the first data processing device 10. To enable the search, data related to a document preferably includes at least text data. The text data can be obtained by optical character recognition (OCR) of the document. A search using an identification number or the like linked to a document can also be performed. In the case where the document is a patent document, the identification number can be an application number, a publication number, a patent number, or another number such as a company control number. The text data, the identification number, and the like can be stored using the database included in the memory unit 120 or the database outside the first data processing device 10.

The language of the document is described below. The document is written in English, Japanese, or another language. Although not limited in any way, the language of the document is preferably English for the natural language processing model using AI in the second data processing device 40. In this specification and the like, languages are distinguished using ordinal numbers and referred to as a first language, a second language, and the like. Not only a document written in the first language but also a document written in the second language can be stored using the database included in the memory unit 120 or the database outside the first data processing device 10.

As a setting of the data processing system, a user's preferred language can be registered. In the case where the user's preferred language is the first language and the natural language processing model using AI in the second data processing device 40 uses the second language, the data processing system may have a translation function. The translation function can be executed by the processing unit 130, by processing using AI in the first data processing device 10, or by processing using the natural language processing model using AI in the second data processing device 40. Such a translation function can improve the convenience of the data processing system.

Next, the document selected by the user is segmented and displayed as denoted by Step S111 in FIG. 3. Note that the document sometimes includes segment information provided in advance, which may be used for display. In the case where the document is a patent document, for example, paragraph numbers, section headings (corresponding to headings such as SUMMARY OF THE INVENTION), or the like can be used as the segment information. Main data processing related to Step S111 is preferably executed by the first data processing device 10 as illustrated in FIG. 5. As the main data processing, the segment information is transmitted to the first information terminal 20a through the output unit 140 together with the data of the document selected earlier. The result of Step S111 is displayed with the first information terminal 20a. As illustrated in FIG. 4A, display on the screen 50 corresponding to Step S111 is segmented into a section 51 and a sentence 52. In the case where the document is a patent document, each section heading such as SUMMARY OF THE INVENTION is displayed as the section 51, and a sentence including a paragraph number is displayed as the sentence 52. In the case where the document includes a drawing, a drawing 53 is displayed together with the section 51 and the sentence 52 side by side on the screen 50. Although the section 51, the sentence 52, and the drawing 53 are displayed in this order from the left on the screen 50, the layout is not limited to this example. Depending on user's settings, the drawing 53, the section 51, and the sentence 52 can be displayed in this order from the left.

The section 51 and the sentence 52 are mutually linked to each other using the memory unit 120 or the processing unit 130. The sentence 52 and the drawing 53 are mutually linked to each other using the memory unit 120 or the processing unit 130. Needless to say, the drawing 53 and the section 51 may be mutually linked to each other using the memory unit 120 or the processing unit 130. With the use of linking information, selection of the section 51 on the screen 50 enables display of the sentence 52 linked to the section 51. Selection of the drawing 53 on the screen 50 enables display of the sentence 52 linked to the drawing 53. In the sentence 52, a drawing number can be highlighted, and selection of the drawing number enables display of the drawing 53 linked to the drawing number. With the use of the section 51, the sentence 52, and the drawing 53 arranged on the screen 50 in this manner, the user can receive document reading support.

Next, the user selects part of the document as denoted by Step S121 in FIG. 3 while referring to the screen 50. The selected part can be an extracted sentence. Specifically, the user selects a specific section 51 as the extracted sentence. Alternatively, the user selects a specific sentence 52 as the extracted sentence. Alternatively, the user selects a specific drawing 53 and selects a sentence 52 describing the selected drawing 53 as the extracted sentence. Such an extraction step is performed in a short time without variation in quality, which is preferable. Main data processing related to Step S121 is preferably executed by the first data processing device 10 as illustrated in FIG. 5. Note that the selected part of the document is included in a prompt.

Here, tokens of the extracted sentence will be described. The number of tokens of the specific section 51 is clearly less than the number of tokens of the entire document and satisfies the condition of being less than or equal to a predetermined value in many cases. Thus, the specific section 51 is preferable as the extracted sentence. The number of tokens of the specific sentence 52 is clearly less than the number of tokens of the entire document and satisfies the condition of being less than or equal to the predetermined value in many cases. Thus, the specific sentence 52 is preferable as the extracted sentence. The number of tokens of the sentence 52 describing the selected drawing 53 is also clearly less than the number of tokens of the entire document and satisfies the condition of being less than or equal to the predetermined value in many cases. Thus, the sentence 52 describing the selected drawing 53 is preferable as the extracted sentence. Such an extracted sentence suits a user's purpose, and processing using that extracted sentence is efficient.

In Step S121, input for the selection is performed with the first information terminal 20a. The screen 50 of the first information terminal 20a includes a selection button 62 as display corresponding to Step S121. The screen 50 in FIG. 4A is provided with the selection button 62 for each section, and the selection button 62 is positioned adjacent to the corresponding section 51. Although the position of the selection button 62 is not limited to this example, such a position of the selection button 62 is preferable because it facilitates operation for selecting the specific section 51.

### Modification Example 1

A modification example of Step S121 in FIG. 3 is described below. In Step S121 of another method, one drawing is selected from the drawing 53, and then a paragraph in which the number of the selected drawing is used is collected and used as the extracted sentence. That is, the sentence 52 related to the drawing can be collected from the document and used as the extracted sentence. In the case where a plurality of paragraphs are collected, the sentence 52 may be collected in the order of appearance in the document. Alternatively, the sentence 52 may be collected with priority according to the frequency of appearance of the number of the selected drawing. For example, when a drawing FIG. A2 is selected, a paragraph in which the drawing number FIG. A2 is used can be selected as part of the document. In that case, a paragraph in which the drawing number FIG. A2 is used a plurality of times is preferably collected with high priority according to the user's purpose. Instead of the sentence 52, a section (e.g., Embodiment 1) including a paragraph in which the drawing number is used may be selected as the extracted sentence. According to the modification example 1, a summary sentence corresponding to the selected drawing 53 can be obtained in Step S161 in FIG. 3. In that case, a prompt like an instruction sentence 2 described later is preferably used. Such use makes it possible to efficiently know what the document describes about the specified drawing.

### Modification Example 2

A modification example of Step S121 in FIG. 3 is described below. In Step S121 of another method, a word used in the document is searched for, and then a paragraph including the word is selected. For example, a text search can be performed using a character string “third insulating film” and a paragraph in which the term “third insulating film” is used can be collected. In a patent document, the term “third insulating film” is often followed by a letter such as “A” or a number such as “100”. A search using the letter or the number may be executed instead of the step of searching for the word. The collected paragraph can be selected as part of the document, and a summary sentence related to the third insulating film can be obtained in Step S161 in FIG. 3. Instead of the paragraph, a section (e.g., Embodiment 1) including the paragraph in which the search word is used may be selected as the extracted sentence. Since insulating films have various functions, the user can accurately understand the function of an insulating film of interest by referring to the summary sentence in Step S161. In that case, a prompt like the instruction sentence 2 described later is preferably used. Such use makes it possible to efficiently know what the document describes about the specified word.

Next, the user inputs the extracted sentence (the selected part of text) and an instruction sentence (instruction to summarize the above part) to the language model as denoted by Step S131 in FIG. 3. In Step S131, the input is performed with the first information terminal 20a, and the instruction sentence is received by the second data processing device 40 as illustrated in FIG. 5. In Step S131, the instruction sentence may be input to the second data processing device 40 through the first data processing device 10. For the input, the screen 50 in FIG. 4A is preferably switched to a screen 50a in FIG. 4B, and the screen 50a includes a text box 63 as display corresponding to Step S131. The user inputs an instruction sentence such as “Summarize the selected part of the document” to the text box 63. The instruction sentence is preferably a fixed phrase. For example, a fixed phrase corresponding to an instruction selected by the user from a list or the like is preferably input to the text box 63. Inputting a fixed phrase as the instruction sentence facilitates inference of tokens. A draft sentence inferred from a usage history of the data processing system can also be provided as the instruction sentence. By using a fixed phrase or an inferred draft sentence as the instruction sentence, the quality of the instruction sentence can be maintained at a certain level even when the user has only a limited knowledge or experience.

The user can edit the text box 63. The edit is preferably based on how part of the document is selected. For example, when the section 51 is selected, an instruction sentence 1 “Generally summarize the selected range” may be used, and when the sentence 52 describing the drawing 53 is selected, an instruction sentence 2 “Summarize the description of the drawing 53 in the selected range” may be used instead of the instruction sentence 1. Since the instruction sentence 1 and the instruction sentence 2 may result in different summary sentences as answer sentences, the user preferably considers the instruction sentence in order to obtain a summary sentence suitable for document reading support.

The language of the instruction sentence is described below. For the natural language processing model using AI in the second data processing device 40, an English prompt is preferably used. Thus, the instruction sentence is preferably written in English. Although the data processing system can have a function of translating the instruction sentence, the convenience of the system is not impaired even when the translation function is not provided because the instruction sentence is often a short sentence or can be a fixed phrase. The document and the instruction sentence are preferably written in the same language but may be written in different languages.

After that, the user selects an execution button 64 on the screen 50a in FIG. 4B. Main data processing related to this step up to the selection of the execution button 64 is preferably executed by the second data processing device 40 as illustrated in FIG. 5.

Next, it is determined whether the number of tokens of the selected part of the document is less than or equal to the predetermined value as denoted by Step S141 in FIG. 3. In Step S141, it may be determined whether the number of tokens of the prompt including the selected part of the document and the instruction sentence is less than or equal to the predetermined value. Main data processing related to Step S141 is preferably executed by the second data processing device 40 as illustrated in FIG. 5 without user input. Thus, display corresponding to Step S141 is not necessary for the screen 50.

In the case where the number of tokens is greater than the predetermined value (in the case of “No” in FIG. 3), an alert is preferably displayed as denoted by Step S142 in FIG. 3. Main data processing related to Step S142 is preferably executed by the second data processing device 40 as illustrated in FIG. 5. The result of the execution is preferably displayed as an alert on the screen 50 of the first information terminal 20a. The displayed alert preferably includes the predetermined value of tokens in addition to the number of tokens of the selected part of the document. For example, the following message is preferably displayed on the screen 50: “Please reduce the length of the extracted sentence because the maximum context length in this system is 8000 tokens but the extracted sentence has 12500 tokens”. Such an alert including a specific message is preferable for the user to understand an error easily. In this case, the process returns to Step S121 as illustrated in FIG. 3, and the user can select part of the document again.

In the case where the number of tokens is less than or equal to the predetermined value (in the case of “Yes” in FIG. 3), a summary sentence is generated as an answer sentence using the language model or the like as denoted by Step S151 in FIG. 3. Specifically, the language model or the like generates a summary sentence as an answer sentence based on the prompt including the extracted sentence and the instruction sentence. Main data processing related to Step S151 is preferably executed by the second data processing device 40.

After that, a summary sentence of the selected part is obtained as denoted by Step S161 in FIG. 3. Display of the summary sentence related to Step S161 is preferably performed with the first information terminal 20a. The screen 50a in FIG. 4B includes a text box 68 for displaying the summary sentence as display corresponding to Step S161. In the case where it takes time to display the summary sentence, a time may be displayed on the screen 50a in FIG. 4B. The time may be a predicted waiting time or an elapsed time since the pressing of the execution button 64.

The language of the summary sentence is described below. For the natural language processing model using AI in the second data processing device 40, an English prompt is preferably used. Thus, the summary sentence as the answer sentence is also preferably written in English. In the case where the user's preferred language is not English, the document reading support system preferably has a translation function. Specifically, the document reading support system may have a function of translating the summary sentence from English into Japanese, for example. Such a translation function can improve the convenience of the system. A language model for executing the translation function is preferably GPT-3 rather than GPT-4. This is because the translation of the summary sentence does not require an enormous amount of data processing. For the document reading support system of one embodiment of the present invention, the document, the instruction sentence, and the answer sentence are preferably in the same language, but the document may be in a first language, the instruction sentence may be in a second language, and the answer sentence may be in the first language. The sentence in the second language corresponds to a translation from the first language.

The document reading support method of one embodiment of the present invention can be ended after Step S161.

### <Additional Function 1>

An additional function 1 in displaying the summary sentence is described below. A word included in the summary sentence displayed in the text box 68 can be highlighted. One example of the word to be highlighted is a word that is not used in the document. In some cases, a summary sentence generated by a language model includes a hallucination and is of low quality. Since the hallucination is often a word that is not used in the document, the word that is not used in the document can be highlighted in the summary sentence in order for the user to easily check the quality of the summary sentence.

### <Additional Function 2>

An additional function 2 in displaying the summary sentence is described below. A word included in the summary sentence displayed in the text box 68 can be linked to the word in the document. When the linked word is selected, the section 51 or the sentence 52 including the word can be displayed on the screen 50. The user can check the quality of the summary sentence by comparing the summary sentence with the displayed content of the section 51 or the sentence 52.

The document reading support method including the above steps can provide a sufficient reading support. In addition, the document reading support method enables an extracted sentence to be obtained by selection of any of a section, a sentence, and a drawing displayed side by side on the screen 50. Thus, a user with no knowledge or experience can also obtain an extracted sentence in a short time with little variation in quality. Moreover, an extracted sentence that suits the user's interest or purpose can be obtained, leading to a summary sentence of high quality. Moreover, an accurate summary sentence can be obtained with a function of translating an instruction sentence from a language suitable for the language model into a user's preferred language.

This embodiment can provide a novel document reading support method. This embodiment can also provide a document reading support method which uses a language model and enables an appropriate prompt to be selected. This embodiment can also provide a document reading support method which uses a language model and enables an accurate answer sentence to be obtained.

This application is based on Japanese Patent Application Serial No. 2023-191708 filed with Japan Patent Office on Nov. 9, 2023, the entire contents of which are hereby incorporated by

What is claimed is:

1. A document reading support method comprising the steps of:
displaying a segmented first document;
receiving selection of a part of the first document as a second document;
inputting the second document and an instruction sentence for summarizing the second document to a language model;
determining whether the number of tokens of the second document is less than or equal to a predetermined value; and
obtaining a summary of the second document determined to have the tokens of less than or equal to the predetermined value.

2. A document reading support method comprising the steps of:
displaying a document segmented into a plurality of sections comprising at least a first section;
receiving selection of the first section;
inputting the first section and an instruction sentence for summarizing the first section to a language model;
determining whether the number of tokens of the first section is less than or equal to a predetermined value; and
obtaining a summary of the first section determined to have the tokens of less than or equal to the predetermined value.

3. A document reading support method comprising the steps of:
displaying a drawing and a segmented document;
receiving selection of the drawing;
collecting a sentence related to the selected drawing from the document;
inputting the collected sentence and an instruction sentence for summarizing the collected sentence to a language model;
determining whether the number of tokens of the collected sentence is less than or equal to a predetermined value; and
obtaining a summary of the collected sentence determined to have the tokens of less than or equal to the predetermined value.

4. The document reading support method according to claim 3,
wherein the document is in a first language,
wherein the instruction sentence is in a second language, and
wherein the summary generated by the language model is in the first language.

5. The document reading support method according to claim 4, wherein the summary is translated into the first language from the second language.

6. The document reading support method according to claim 3, further comprising the step of:
displaying the summary generated by the language model,
wherein a first word not used in the document is highlighted in the displayed summary.

7. The document reading support method according to claim 3, further comprising the step of:
displaying the summary generated by the language model,
wherein a sentence comprising a second word in the document is displayed when the second word is selected in the displayed summary.

8. The document reading support method according to claim 3,
wherein an alert is displayed when the number of tokens is greater than the predetermined value in the step of determining whether the number of tokens is less than or equal to the predetermined value.
